(19) United States
(12) Patent Application Publication
(10) Pub. No.: US 2018/0004947 A1
(43) Pub. Date: Jan. 4, 2018

(54) ENHANCED CONTROL TRANSFER SECURITY

(71) Applicant: Intel Corporation, Santa Clara, CA (US)

(72) Inventors: XIAONING LI, Santa Clara, CA (US); RAVI L. SAHITA, Beaverton, OR (US); VEDVYAS SHANBHOGUE, Austin, TX (US)

(73) Assignee: Intel Corporation, Santa Clara, CA (US)

(21) Appl. No.: 15/201,444

(22) Filed: Jul. 2, 2016

(51) Int. Cl. G06F 21/56; G06F 21/52

(52) U.S. Cl. CPC G06F 21/566; G06F 21/52; G06F 2221/033

(57) ABSTRACT

One embodiment provides a system. The system includes a processor comprising at least one processing unit; a memory; and control transfer (CT) logic. The CT logic is to determine whether a next instruction is a control transfer termination (CTT) when a prior instruction is a control transfer instruction (CTI). The CT logic is to determine whether the CTT is an external CTT, if the next instruction is the CTT; determine whether the prior instruction is an external CTI, if the CTT is the external CTT; and notify an external CTT fault, if the prior instruction is not the external CTI.

### FIELD

The present disclosure relates to control transfer security, in particular to, enhanced control transfer security.

### BACKGROUND

Computer software, i.e., “code”, may be attacked by adding malicious code and/or reusing existing code. The addition of malicious code may be thwarted by preventing both writing to and executing a same area of memory. In a code reuse attack, existing code is utilized for a malicious purpose. Code reuse attacks may utilize knowledge of, for example, external function libraries, to identify code sequences to be exploited.

One example code reuse attack is return oriented programming (ROP) in which relatively short code sequences that end in a return instruction are found in existing machine code and executed in an order determined by an attacker. ROP may be implemented by taking control of the stack. Effectiveness of return oriented programming may be diminished by mechanisms configured to detect an abundance of return instructions in an executed code sequence. Call oriented programming (COP) is another example code reuse attack. COP may utilize call instructions and/or jump instructions to transfer control to an attacker's selected target destination rather than a programmer's original target destination.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of an enhanced control transfer security system consistent with several embodiments of the present disclosure; and

FIG. 2 is a flowchart of compiler enhanced control transfer security operations according to various embodiments of the present disclosure;

FIG. 3 is a flowchart of runtime enhanced control transfer security operations according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Code reuse attacks may exploit variable instruction length so that individual bytes of an instruction may be interpreted differently depending on starting location. Code reuse attacks may be configured to manipulate the stack. For example, a call instruction may be configured to push an address of a next instruction onto the stack. The address of the next instruction may be manipulated by an attacker using, e.g., stack overflow. Conversely, a return instruction may be configured to pop a return address from the stack.

In one example, COP may be implemented by taking control of the stack and/or redirecting a function pointer in, for example, a virtual function table (“vtable”). In another example, COP may be implemented by exploiting a use-after-free memory allocation error to redirect the function pointer in the vtable. Thus, COP may utilize the vtable to transfer control to an attacker selected location. The vtable is used in, for example, object oriented programming, to provide pointers to functions when the respective address of each function may not yet be known. For example, the object and functions may be included in a library. An application that includes calls to such objects and/or functions may be linked to the library after being compiled. In other words, application object code may be linked to library object code after compile time and prior to runtime and/or dynamically during runtime.

An object may include one or more internal functions. The object may further include an exposed function. The exposed function may be accessed (e.g., called or jumped to) from other code external to the object. The internal functions may be accessed by the object and/or from other functions included in the object. In other words, the internal functions may not be exposed and, during normal operation, may not be accessed from other code external to the object. A pointer to the vtable may be associated with the object at compile time. The associated function pointers may then be populated as part of link operations after compile time and/or during runtime. The pointers may correspond to offsets relative to a vtable base address.

A COP attack may target the vtable and overwrite a legitimate function pointer with a malicious function pointer using, for example, stack buffer overflows and/or use-after-free errors. The malicious function pointer may then be utilized to transfer control to an attacker-selected location different from the programmer's intended (i.e., legitimate) location. An attacker may exploit known and/or discovered vulnerabilities in, for example, existing libraries that may be known and relatively broadly used.

Generally, this disclosure relates to enhanced control transfer security. A method and/or system are configured to increase a likelihood of detecting a COP attack. A method and/or system are configured to utilize internal and external control transfer instructions (CTIs) and internal and external control transfer terminations (CTTs) to detect at least some COP attacks. Internal CTIs include internal call and jump instructions, e.g., CALL and JMP. External CTIs include external call and jump instructions, e.g., EXCALL and EXJMP. CTTs correspond to tags. For example, ENDBRANCH is an internal CTT and EXENDBRANCH is an external CTT. The ENDBRANCH and EXENDBRANCH tags may be configured to execute as no operation (i.e., NOP) instructions.

A CTT may be placed at a target destination of a CTI, e.g., by a compiler at compile time. The target destination may correspond to an exposed function or an internal function. In other words, a first instruction at a target destination of a CTI is configured to be a CTT. Whether the CTT is external or internal may be determined based, at least in part, on whether the target may be accessed by internal and/or external other code or may only be accessed by external other code. As used herein “other code” is code that includes a CTI to a target function. A call or jump instruction associated with an exposed function is an external CTI. A call or jump instruction associated with an internal function is an internal CTI. Thus, at compile time, the compiler may be configured to generate corresponding object code that includes CTIs and associated CTTs.

At runtime, control transfer (CT) logic may be configured to determine whether a CTI is followed by a CTT and to trigger a general CTT fault, if it is not. If the CTI is followed by the CTT and the CTT is an external CTT, the CT logic may be further configured to determine whether the CTI is an external CTI and to trigger an external CTT fault, if it is not.

Thus, malicious code that utilizes an internal function to call or jump to an exposed function tagged with an external CTT may be detected and identified as attack code. For example, targets tagged with the external CTT may only be accessed by external other code, e.g., external CTIs. Thus, control transfer attacks may be impeded by CTT tags. Attacks that exploit the vtable may be further impeded by differentiating between internal and external CTIs and internal and external CTTs.

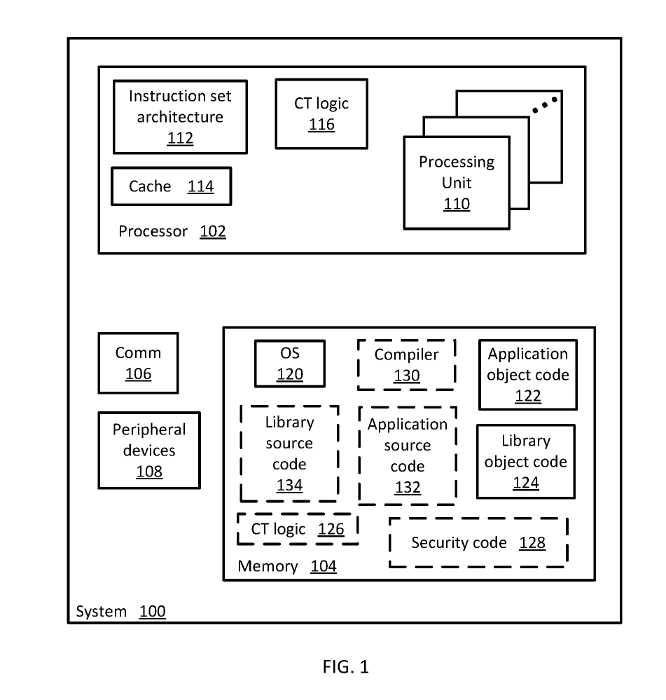

FIG. 1 illustrates a functional block diagram of an enhanced control transfer security system 100 consistent with several embodiments of the present disclosure. Enhanced control transfer security system 100 may include, but is not limited to, a mobile telephone including, but not limited to a smart phone (e.g., iPhone®, Android®-based phone, Blackberry®, Symbian®-based phone, Palm®-based phone, etc.); a wearable device (e.g., wearable computer, “smart” watches, smart glasses, smart clothing, etc.) and/or system; an Internet of Things (IoT) networked device including, but not limited to, a sensor system (e.g., environmental, position, motion, etc.) and/or a sensor network (wired and/or wireless); a computing system (e.g., a server, a workstation computer, a desktop computer, a laptop computer, a tablet computer (e.g., iPad®, GalaxyTab® and the like), a phablet computer, an ultraportable computer, an ultramobile computer, a netbook computer and/or a subnotebook computer; etc.

Enhanced control transfer security system 100 may include a processor 102, memory 104, a communication interface “Comm” 106 and one or more peripheral devices 108. Communication interface 106 is configured to provide communication capability, wired and/or wireless, to system 100. Peripheral devices 108 may include internal and/or external storage devices including, but not limited to, hard disk drives, solid-state storage devices, etc., and/or user interface devices including, but not limited to, a user input device (e.g., keyboard, a keypad, touchpad, mouse, microphone, etc.), a display (including a touch sensitive display), etc.

Processor 102 may include one or more processing units, e.g., processing unit 110, an instruction set architecture (ISA) 112, a cache memory 114 and control transfer (CT) logic 116. For example, CT logic 116 may be implemented in circuitry. In another example, CT logic 116 may be implemented as micro-operations (μOPs) and/or may be included in ISA 112.

Memory 104 is configured to store an operating system (OS) 120, an application object code 122, a library object code 124 and CT logic 126. Memory 104 may be further configured to store a compiler 130, an application source code 132, a library source code 134 and/or security code 128. CT logic 126 may be included in compiler 130 and/or may include object code accessible by compiler 130. The compiler 130, application source code 132 and/or library source code 134 may be present at compile time and may or may not be present at runtime.

Compiler 130 is configured to compile application source code 132 and/or library source code 134 to generate application object code 122 and library object code 124, respectively. Application object code 122 and/or library object code 124 may each include internal and/or external other code, as described herein. The application source code 132 and library source code 134 may be written in a high-level language, e.g., C++, and/or another object-oriented programming language. The application object code 122 and library object code 124 may then be linked after compile time and prior to runtime and/or dynamically at runtime. The application object code 122 and/or library object code 124 may include a plurality of μOPs. The application object code 122 and library object code 124 may then be executed at runtime by processor 102 including, e.g., processing unit 110.

Application source code 132 and/or library source code 134 may include one or more control transfer instructions (CTIs) including call instructions (e.g., CALL and/or EXCALL) and jump (e.g., JMP and/or EXJMP) instructions. A call instruction is configured to call an object or function and may be configured to return after performing the operations of the object and/or function. A jump instruction may jump to an object or function and is generally not configured to return.

In object-oriented programming, an object may include one or more internal functions that are not exposed outside the object. The object may further include an exposed function. Exposed functions may be callable by other code from outside the object as well as functions included in the object. Internal functions may not be exposed outside the object and are configured to be accessed by other functions included in the object.

Library source code 134 and library object code 124 (i.e., “library code 124 and 134”) may include a plurality of objects and/or functions that may be standardized and/or known. For example, library code 124 and 134 may include a C++ library, e.g., libc. Library code 124 and 134 may include one or more exposed application programming interfaces (APIs). The APIs may include one or more objects with corresponding internal and/or exposed functions. In another example, an object may correspond to a base class and internal functions may correspond to subclasses associated with the base class. Thus, a selected object may include one or more internal functions. The selected object may further include an exposed function. The internal functions may not be exposed outside of the object. In other words, other code external to the object may access the exposed function but may not directly access the object's internal functions. Object code internal to the object, i.e., function object code, may access the internal functions and may or may not access other objects.

Application source code 132 may be configured to call and/or jump to one or more objects and/or exposed functions included in library code 124 and 134. The compiler 130 may be configured to implement a pointer to a virtual function table (“vtable”) for each object in application source code 132. Library object code 134 may include one or more pointers to vtables associated with each object and/or compiler 130 may be configured to implement the pointer to the corresponding vtable for each object included in library source code 134.

Each vtable is configured to include pointers to each function (internal or exposed) associated with the corresponding object. The vtable construct is configured to allow compiling individual source code modules into individual object code modules for later linking. The linking and vtable creation may occur prior to execution of the application object code and/or during execution (i.e., at runtime) when a selected library object is created. In other words, at compile time, the addresses of the object and associated functions may not be known. The vtable is configured to receive and store the addresses when they become known, e.g., when linked. For example, dynamic link libraries (DLLs) may be linked dynamically during runtime

The vtables may be targeted for attack and the associated pointers may be corrupted by an attacker to point to a location selected by the attacker and not by the programmer. In a code reuse attack, as described herein, existing code is repurposed by an attacker for possibly nefarious purposes. Such malicious code may result in vtable pointers pointing to object code that was not designed to be a target of a control transfer instruction (CTI). In other words, the destination object code may not correspond to a legitimate target.

To reduce the likelihood of a success of such a code reuse attack, control transfer terminations (CTTs) may be used. CTTs are configured to identify legitimate targets of a CTI. For example, compiler 130 and/or CT logic 136 may be configured to identify CTIs and corresponding targets of the CTIs. CTIs may include, for example, call instructions and jump instructions. Compiler 130 and/or CT logic 136 may be configured to add a CTT at each target location for a CTI. The CTT may be a tag that executes as a NOP.

At compile time, whether a source code element is a CTI or a target function may be determined by compiler 130 and/or CT logic 136. If the source code element is a CTI, then compiler 130 and/or CT logic 136 may be configured to determine whether a target of the CTI is external relative to the CTI. A target function that is included in a different object from the CTI may be external. For example, an exported API may correspond to an external target. A target function that is included in a same object as the CTI may not be external. If the target function is external relative to the CTI, then compiler 130 and/or CT logic 136 may be configured to implement corresponding external CTI (e.g., EXCALL or EXJMP) object code. If the target function is not external relative to the CTI, then compiler 130 and/or CT logic 136 may implement internal CTI (e.g., CALL or JMP) object code. Thus, compiler 130 and/or CT logic 136 may be configured to implement an appropriate, i.e., internal or external, CTI based, at least in part, on whether the target function is internal or external with respect to the CTI.

A target function may be exposed (i.e., accessible from outside a corresponding object) or maybe internal (i.e., accessible only from within the object). Whether the target function is exposed or internal may be known by the compiler 130 and/or CT logic 136 at compile time based, at least in part, on the source code being compiled. Each internal function may then be tagged with an internal CTT, e.g., ENDBRANCH, by the compiler 130 and/or CT logic 136. The CTTs are configured to be utilized at runtime as indicators of a legitimate target of a CTI. The CTTs may be configured to execute as NOPs. A CTI that is not followed by a CTT may then trigger a general CTT fault, as described herein.

Each exposed function may be tagged with an external CTT, e.g., EXENDBRANCH, or an internal CTT, e.g., ENDBRANCH, by the compiler 130 and/or CT logic 136 at compile time. Whether the exposed function is tagged with an internal CTT or external CTT is related to whether the exposed function may be accessed by an internal function in the same object or may only be accessed by external other code. If the exposed function may be accessed by an internal function in a same object (in addition to external other code), then the exposed function may be tagged with an internal CTT. If the exposed function may be accessed by only external other code, then the exposed function may be tagged with an external CTT. Thus, legitimate access to an exposed function by an internal function may be preserved.

Thus, if the source code element is a target function, then compiler 130 and/or CT logic 136 may be configured to determine whether the target function is accessible only by external other code. Compiler 130 and/or CT logic 136 may then tag the target function with an external CTT (e.g., EXENDBRANCH) if the target function is accessible only by other external code. Compiler 130 and/or CT logic 136 may tag the target function with an internal CTT (e.g., ENDBRANCH) if the target function is not accessible only by external other code. In other words, internal functions and exposed functions that are legitimately accessible by internal functions may be tagged with an internal CTT. Exposed functions that may only be accessed by external other object code may be tagged with an external CTT.

At runtime, processor 102, e.g., processing unit 110, may be configured to execute application object code 122 and/or library object code 124. CT logic 116 may be configured to monitor the execution of the object code 122 and/or 124 and to detect CTT faults, if any. Such fault detection may be based, at least in part, on a type of CTI, e.g., external or internal. Such fault detection may be further based, at least in part, on whether a CTT follows a CTI and based, at least in part, on a type of CTT, e.g., external or internal. CT logic 116 may be configured to communicate one or more detected CTT faults to security code 128.

CT logic 116 may be configured to detect attempts by internal CTIs to access targets tagged with an external CTT. Internal CTIs, e.g., internal call and/or jump instructions, e.g., CALL and/or JMP, may only legitimately terminate on internal CTTs, e.g., ENDBRANCH. External CTIs, e.g., EXCALL and/or EXJMP, may legitimately target, i.e., terminate on, internal CTTs and/or external CTTs. Thus, an internal CTI that terminates on an external CTT may indicate an attack operation.

When processor 102 executes a CTI, CT logic 116 may be configured to determine whether a next instruction is a CTT. If the next instruction, i.e., instruction following the CTI, is not a CTT, CT logic 116 may be configured to notify a general CTT fault. Execution may then be terminated. The general CTT fault is configured to indicate that a CTT did not follow a CTI. The general CTT fault is independent of whether the CTI was internal or external.

If the next instruction is a CTT, CT logic 116 may be configured to determine whether the CTT is an external CTT. If the CTT is an external CTT, then CT logic 116 may be configured to determine whether the CTI was an external CTI. If the CTT was an external CTT and the CTI was not an external CTI, then the CT logic 116 may be configured to notify an external CTT fault and program execution may halt. The external CTT fault is configured to indicate that an internal CTI attempted to access an external object and, may thus be a result of an attack tagged with an external CTT.

In an embodiment, security code 128 may be configured to intercept APIs with a reversed external CTT. For example, security code 128 and/or OS 130 may be configured to utilize a reversed external CTT to intentionally trigger a CTT fault. Security code 128 and/or OS 130 may then intercept a context to support monitoring operations. The monitoring operations may include, for example, logging.

Thus, internal and external control transfer instructions (CTIs) and internal and external control transfer terminations (CTTs) may be utilized to detect at least some COP attacks. The general CTT fault and external CTT fault are configured to indicate absence of a CTT following a CTI and attempts by internal CTIs to access objects tagged with external CTTs, respectively. Appropriate internal or external CTIs and internal or external CTTs may be implemented at compile time. Exposed functions and/or exposed APIs that may only be accessed by external CTIs may be tagged with external CTTs. Thus, effectiveness of code reuse attacks configured to manipulate vtables may be impeded. In other words, while attacks that utilize internal CTIs and terminate on internal CTTs may not be detected, attacks directed to exposed APIs may be detected.

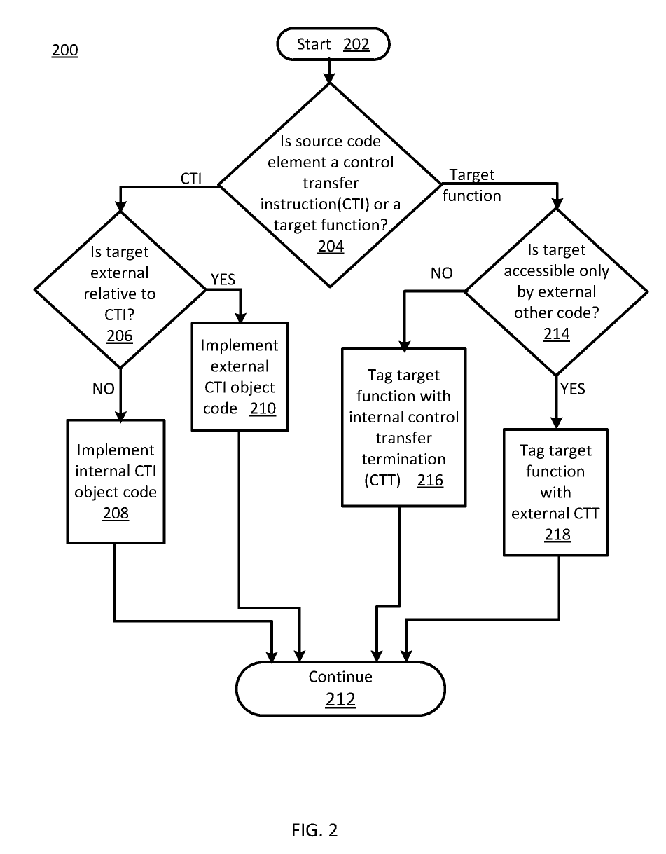

FIG. 2 is a flowchart 200 of compiler enhanced control transfer security operations according to various embodiments of the present disclosure. In particular, the flowchart 200 illustrates implementing CTI object code and tagging targets with appropriate CTTs. The operations may be performed, for example, by compiler 130 and/or CT logic 126 of FIG. 1.

Operations of this embodiment may begin with start at operation 202. Whether a source code element is a control transfer instruction (CTI) or a target function may be determined at operation 204. If the source code element is a CTI, whether a target is external relative to the CTI may be determined at operation 206. If the target is not external, internal CTI object code may be implemented at operation 208. Program flow may then continue at operation 212. If the target is external, external CTI object code may be implemented at operation 210. Program flow may then continue at operation 212.

If the source code element is a target function, whether a target is accessible (i.e., may be called or jumped to) only by external other code may be determined at operation 214. If the target is not accessible only by external other code, the target function may be tagged with an internal CTT at operation 216. In other words, if the target is accessible by internal and/or external other code, the target function may be tagged with an internal CTT. Program flow may then continue at operation 212. If the target is only accessible by external other code, the target function may be tagged with an external CTT at operation 218. Program flow may then continue at operation 212.

Thus, at compile time, internal or external CTIs may be implemented based, at least in part, on whether the target function is internal or external relative to the CTI. The target object or target function may then be tagged with an appropriate CTT. Thus, compiler knowledge of functions and, e.g., exposed APIs, may be utilized to select between internal and external CTIs and internal and external CTTs. A mechanism may thus be provided for use at runtime configured to detect a COP attack.

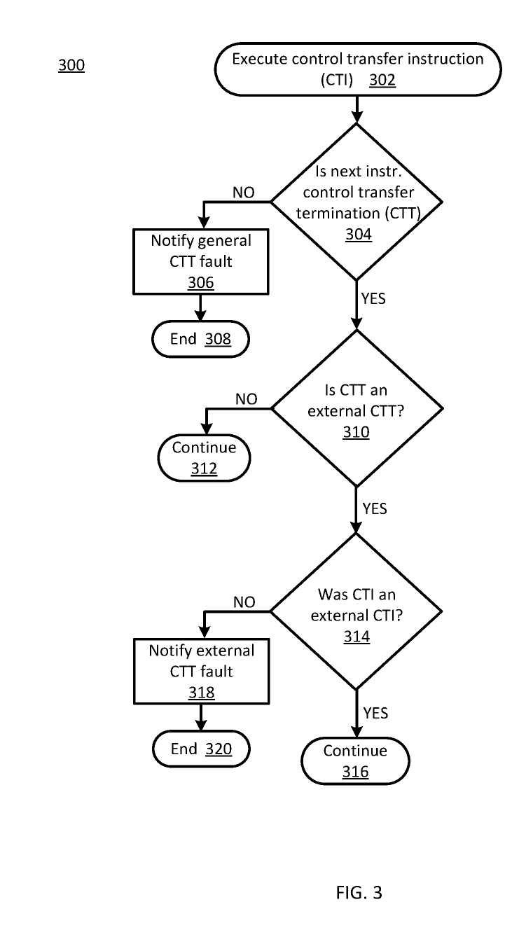

FIG. 3 is a flowchart 300 of runtime enhanced control transfer security operations according to various embodiments of the present disclosure. In particular, the flowchart 300 illustrates utilizing internal and external CTTs at runtime. The operations may be performed, for example, by OS 120 and/or CT logic 116 of FIG. 1.

Operations of this embodiment may begin with execution of a control transfer instruction (CTI) 302. Whether a next instruction is a control transfer termination (CTT) may be determined at operation 304. If the next instruction is not a CTT, a general CTT fault may be notified at operation 306. Program flow may then end at operation 308. If the next instruction is a CTT, whether the CTT is an external CTT may be determined at operation 310. If the CTT is not an external CTT, program flow may continue at operation 312. If the CTT is an external CTT, then whether the CTI was an external CTI may be determined at operation 314. If the CTI was an external CTI, program flow may then continue at operation 316. If the CTI was not an external CTI, then an external CTT fault may be notified at operation 318. Program flow may then and at operation 320.

Thus, at runtime a general CTT fault may be notified if a CTT does not follow a CTI. Thus, a COP attack that redirects to an attacker-selected location that is not a CTT may be detected. An external CTT fault may be notified if an external CTT was not preceded by an external CTI. An external CTT preceded by an internal CTI may thus be detected.

While the flowcharts of FIGS. 2 and 3 illustrate operations according various embodiments, it is to be understood that not all of the operations depicted in FIGS. 2 and 3 are necessary for other embodiments. In addition, it is fully contemplated herein that in other embodiments of the present disclosure, the operations depicted in FIGS. 2 and/or 3 and/or other operations described herein may be combined in a manner not specifically shown in any of the drawings, and such embodiments may include less or more operations than are illustrated in FIGS. 2 and 3. Thus, claims directed to features and/or operations that are not exactly shown in one drawing are deemed within the scope and content of the present disclosure.

Generally, this disclosure relates to enhanced control transfer security. A method and/or system are configured to increase a likelihood of detecting a COP attack. A method and/or system are configured to utilize internal and external CTIs and internal and external CTTs to detect at least some COP attacks. A CTT may be placed directly following a target destination of a CTI, e.g., by a compiler at compile time. Whether the CTT is external or internal may be determined based, at least in part, on whether the target may be accessed by internal and/or external other code or may only be accessed by external other code. Thus, at compile time, the compiler may be configured to generate corresponding object code that includes CTIs and appropriate CTTs.

At runtime, control transfer (CT) logic may be configured to determine whether a CTI is followed by a CTT and to trigger a general CTT fault, if it is not. If the CTI is followed by the CTT and the CTT is an external CTT, the CT logic may be further configured to determine whether the CTI is an external CTI and to trigger an external CTT fault, if it is not.

Thus, malicious code that may utilize an internal function to call or jump to an exposed function that may only be accessed by external other code may be detected and identified as attack code. Control transfer attacks may thus be impeded by CTT tags. Attacks that exploit the vtable may be further impeded by CT logic that differentiates between internal and external CTIs and internal and external CTTs.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

The foregoing provides example system architectures and methodologies, however, modifications to the present disclosure are possible. The processor may include one or more processor cores and may be configured to execute system software. System software may include, for example, an operating system. Device memory may include I/O memory buffers configured to store one or more data packets that are to be transmitted by, or received by, a network interface.

The operating system (OS) 120 may be configured to manage system resources and control tasks that are run on, e.g., system 100. For example, the OS may be implemented using Microsoft® Windows®, HP-UX®, Linux®, or UNIX®, although other operating systems may be used. In another example, the OS may be implemented using Android™, iOS, Windows Phone® or BlackBerry®. In some embodiments, the OS may be replaced by a virtual machine monitor (or hypervisor) which may provide a layer of abstraction for underlying hardware to various operating systems (virtual machines) running on one or more processing units.

Memory 104 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

In some embodiments, a Verilog hardware description language (HDL) may be used to specify circuit and/or logic implementation(s) for the various logic and/or circuitry described herein. For example, in one embodiment, the HDL may comply or be compatible with IEEE standard 62530-2011: SystemVerilog—Unified Hardware Design, Specification, and Verification Language, dated Jul. 7, 2011; IEEE Std 1800™-2012: IEEE Standard for SystemVerilog-Unified Hardware Design, Specification, and Verification Language, released Feb. 21, 2013; IEEE standard 1364-2005: IEEE Standard for Verilog Hardware Description Language, dated Apr. 18, 2006 and/or other versions of Verilog HDL and/or SystemVerilog standards.

### EXAMPLES

Examples of the present disclosure include subject material such as a method, means for performing acts of the method, a device, or of an apparatus or system related to enhanced control transfer security, as discussed below.

### Example 1

According to this example, there is provided a method. The method includes determining, by control transfer (CT) logic, whether a next instruction is a control transfer termination (CTT), when a prior instruction is a control transfer instruction (CTI); determining, by the CT logic, whether the CTT is an external CTT, if the next instruction is the CTT; determining, by the CT logic, whether the prior instruction is an external CTI, if the CTT is the external CTT; and notifying, by the CT logic, an external CTT fault, if the prior instruction is not the external CTI.

### Example 2

This example includes the elements of example 1, and further includes notifying, by the CT logic, a general CTT fault, if the next instruction is not the CTT.

### Example 3

This example includes the elements of example 1, wherein the CTI is an internal CTI or an external CTI.

### Example 4

This example includes the elements of example 3, wherein the internal CTI is selected from the group including an internal call instruction (“CALL”) and an internal jump instruction (“JMP”), and the external CTI is selected from the group including an external call instruction (“EXCALL”) and an external jump instruction (“EXJMP”).

### Example 5

This example includes the elements of example 1, wherein the CTT is an internal CTT or an external CTT.

### Example 6

This example includes the elements of example 5, wherein the internal CTT is an ENDBRANCH and the external CTT is an EXENDBRANCH.

### Example 7

This example includes the elements of example 1, wherein the CTT is to execute as a NOP (no operation) instruction.

### Example 8

According to this example, there is provided a method. The method includes determining, by control transfer (CT) logic, whether a target of a control transfer instruction (CTI) is external relative to the CTI; and implementing, by the CT logic, an internal CTI object code, if the target is not external, or implementing, by the CT logic, an external CTI object code, if the target is external.

### Example 9

This example includes the elements of example 8, and further includes determining, by the CT logic, whether the target is accessible only by external other code and tagging, by the CT logic, a target function with an internal control transfer termination (CTT), if the target is not accessible by only external other code, or tagging, by the CT logic, a target object with an external CTT, if the target is accessible only by the external other code.

### Example 10

This example includes the elements of example 8, wherein the CTI is an internal CTI or an external CTI.

### Example 11

This example includes the elements of example 10, wherein the internal CTI is selected from the group including an internal call instruction (“CALL”) and an internal jump instruction (“JMP”), and the external CTI is selected from the group including an external call instruction (“EXCALL”) and an external jump instruction (“EXJMP”).

### Example 12

This example includes the elements of example 9, wherein the internal CTT is an ENDBRANCH and the external CTT is an EXENDBRANCH.

### Example 13

This example includes the elements of example 8, wherein the CTT is to execute as a NOP (no operation) instruction.

### Example 14

According to this example, there is provided a system. The system includes a processor; a memory; and control transfer (CT) logic. The processor includes at least one processing unit. The control transfer (CT) logic is to determine whether a next instruction is a control transfer termination (CTT) when a prior instruction is a control transfer instruction (CTI). The control transfer (CT) logic is to determine whether the CTT is an external CTT, if the next instruction is the CTT. The control transfer (CT) logic is to determine whether the prior instruction is an external CTI, if the CTT is the external CTT, and the control transfer (CT) logic notifies an external CTT fault, if the prior instruction is not the external CTI.

### Example 15

This example includes the elements of example 14, wherein the CT logic is to notify a general CTT fault, if the next instruction is not the CTT.

### Example 16

This example includes the elements of example 14, wherein the CTI is an internal CTI or an external CTI.

### Example 17

This example includes the elements of example 16, wherein the internal CTI is selected from the group including an internal call instruction (“CALL”) and an internal jump instruction (“JMP”), and the external CTI is selected from the group including an external call instruction (“EXCALL”) and an external jump instruction (“EXJMP”).

### Example 18

This example includes the elements according to any one of examples 14 through 16, wherein the CTT is an internal CTT or an external CTT.

### Example 19

This example includes the elements according to any one of examples 14 through 16, wherein the internal CTT is an ENDBRANCH and the external CTT is an EXENDBRANCH.

### Example 20

This example includes the elements according to any one of examples 14 through 16, wherein the CTT is to execute as a NOP (no operation) instruction.

### Example 21

According to this example, there is provided a system. The system includes a processor including at least one processing unit; a memory; and control transfer (CT) logic. The control transfer (CT) logic is to determine whether a target of a control transfer instruction (CTI) is external. The control transfer (CT) logic is to implement an internal CTI object code, if the target is not external, or is to implement an external CTI object code, if the target is external.

### Example 22

This example includes the elements of example 21, wherein the CT logic is to determine whether the target will be accessed only by an external other code, and to tag a target function with an internal control transfer termination (CTT), if the target will not be accessed only by the external other code, or tag a target object with an external CTT, if the target will be accessed only by the external other code.

### Example 23

This example includes the elements of example 21, wherein the CTI is an internal CTI or an external CTI.

### Example 24

The system according to any one of examples 21 through 23, wherein the internal CTI is selected from the group including an internal call instruction (“CALL”) and an internal jump instruction (“JMP”), and the external CTI is selected from the group including an external call instruction (“EXCALL”) and an external jump instruction (“EXJMP”).

### Example 25

This example includes the elements according to any one of examples 21 through 23, wherein the internal CTT is an ENDBRANCH and the external CTT is an EXENDBRANCH.

### Example 26

This example includes the elements according to any one of examples 21 through 23, wherein the CTT is to execute as a NOP (no operation) instruction.

### Example 27

According to this example, there is provided a computer readable storage device. The device has stored thereon instructions that when executed by one or more processors result in the following operations including: determining whether a next instruction is a control transfer termination (CTT), when a prior instruction is a control transfer instruction (CTI); determining whether the CTT is an external CTT, if the next instruction is the CTT; determining whether the prior instruction is an external CTI, if the CTT is the external CTT; and notifying an external CTT fault, if the prior instruction is not the external CTI.

### Example 28

This example includes the elements of example 27, wherein the instructions that when executed on one or more processors results in the following additional operations including notifying a general CTT fault, if the next instruction is not the CTT.

### Example 29

This example includes the elements of example 27, wherein the CTI is an internal CTI or an external CTI.

### Example 30

This example includes the elements of example 29, wherein the internal CTI is selected from the group including an internal call instruction (“CALL”) and an internal jump instruction (“JMP”), and the external CTI is selected from the group including an external call instruction (“EXCALL”) and an external jump instruction (“EXJMP”).

### Example 31

This example includes the elements according to any one of examples 27 through 29, wherein the CTT is an internal CTT or an external CTT.

### Example 32

This example includes the elements of example 31, wherein the internal CTT is an ENDBRANCH and the external CTT is an EXENDBRANCH.

### Example 33

This example includes the elements according to any one of examples 27 through 29, wherein the CTT is to execute as a NOP (no operation) instruction.

### Example 34

According to this example, there is provided a computer readable storage device. The device has stored thereon instructions that when executed by one or more processors result in the following operations including: determining whether a target of a control transfer instruction (CTI) is external relative to the CTI; and implementing an internal CTI object code, if the target is not external, or implementing an external CTI object code, if the target is external.

### Example 35

This example includes the elements of example 34, wherein the instructions that when executed on one or more processors results in the following additional operations including determining whether the target is accessible only by external other code and tagging a target function with an internal control transfer termination (CTT), if the target is not accessible by only external other code, or tagging a target object with an external CTT, if the target is accessible only by the external other code.

### Example 36

This example includes the elements of example 34, wherein the CTI is an internal CTI or an external CTI.

### Example 37

This example includes the elements of example 36, wherein the internal CTI is selected from the group including an internal call instruction (“CALL”) and an internal jump instruction (“JMP”), and the external CTI is selected from the group including an external call instruction (“EXCALL”) and an external jump instruction (“EXJMP”).

### Example 38

This example includes the elements of example 35, wherein the internal CTT is an ENDBRANCH and the external CTT is an EXENDBRANCH.

### Example 39

This example includes the elements according to any one of examples 34 through 36, wherein the CTT is to execute as a NOP (no operation) instruction.

### Example 40

According to this example, there is provided a device. The device includes means for determining, by control transfer (CT) logic, whether a next instruction is a control transfer termination (CTT), when a prior instruction is a control transfer instruction (CTI). The device includes means for determining, by the CT logic, whether the CTT is an external CTT, if the next instruction is the CTT. The device includes means for determining, by the CT logic, whether the prior instruction is an external CTI, if the CTT is the external CTT; and the device includes means for notifying, by the CT logic, an external CTT fault, if the prior instruction is not the external CTI.

### Example 41

This example includes the elements of example 40, and further includes means for notifying, by the CT logic, a general CTT fault, if the next instruction is not the CTT.

### Example 42

This example includes the elements of example 40, wherein the CTI is an internal CTI or an external CTI.

### Example 43

This example includes the elements of example 42, wherein the internal CTI is selected from the group including an internal call instruction (“CALL”) and an internal jump instruction (“JMP”), and the external CTI is selected from the group including an external call instruction (“EXCALL”) and an external jump instruction (“EXJMP”).

### Example 44

This example includes the elements according to any one of examples 40 through 42, wherein the CTT is an internal CTT or an external CTT.

### Example 45

This example includes the elements of example 44, wherein the internal CTT is an ENDBRANCH and the external CTT is an EXENDBRANCH.

### Example 46

This example includes the elements according to any one of examples 40 through 42, wherein the CTT is to execute as a NOP (no operation) instruction.

### Example 47

According to this example, there is provided a device. The device includes means for determining, by control transfer (CT) logic, whether a target of a control transfer instruction (CTI) is external relative to the CTI. The device includes means for implementing, by the CT logic, an internal CTI object code, if the target is not external, or means for implementing, by the CT logic, an external CTI object code, if the target is external.

### Example 48

This example includes the elements of example 47, and further includes means for determining, by the CT logic, whether the target is accessible only by external other code and tagging, by the CT logic, a target function with an internal control transfer termination (CTT), if the target is not accessible by only external other code, or tagging, by the CT logic, a target object with an external CTT, if the target is accessible only by the external other code.

### Example 49

This example includes the elements of example 47, wherein the CTI is an internal CTI or an external CTI.

### Example 50

This example includes the elements of example 49, wherein the internal CTI is selected from the group including an internal call instruction (“CALL”) and an internal jump instruction (“JMP”), and the external CTI is selected from the group including an external call instruction (“EXCALL”) and an external jump instruction (“EXJMP”).

### Example 51

This example includes the elements of example 48, wherein the internal CTT is an ENDBRANCH and the external CTT is an EXENDBRANCH.

### Example 52

This example includes the elements according to any one of examples 47 through 49, wherein the CTT is to execute as a NOP (no operation) instruction.

### Example 53

According to this example, there is provided a system. The system includes at least one device arranged to perform the method of any one of examples 1 to 7.

### Example 54

According to this example, there is provided a device. The device includes means to perform the method of any one of examples 1 to 7.

### Example 55

According to this example, there is provided a computer readable storage device. The device has stored thereon instructions that when executed by one or more processors result in the following operations including the method according to any one of examples 1 through 7.

### Example 56

According to this example, there is provided a system. The system includes at least one device arranged to perform the method of any one of examples 8 to 13.

### Example 57

According to this example, there is provided a device. The device includes means to perform the method of any one of examples 8 to 13.

### Example 58

According to this example, there is provided a computer readable storage device. The device has stored thereon instructions that when executed by one or more processors result in the following operations including the method according to any one of examples 8 through 13.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A control transfer security method comprising:
determining, by control transfer (CT) logic, whether a next instruction is a control transfer termination (CTT), when a prior instruction is a control transfer instruction (CTI);
determining, by the CT logic, whether the CTT is an external CTT, if the next instruction is the CTT;
determining, by the CT logic, whether the prior instruction is an external CTI, if the CTT is the external CTT; and
notifying, by the CT logic, an external CTT fault, if the prior instruction is not the external CTI.

2. The method of claim 1, further comprising notifying, by the CT logic, a general CTT fault, if the next instruction is not the CTT.

3. The method of claim 1, wherein the CTI is an internal CTI or an external CTI.

4. The method of claim 3, wherein the internal CTI is selected from the group comprising an internal call instruction (“CALL”) and an internal jump instruction (“JMP”), and the external CTI is selected from the group comprising an external call instruction (“EXCALL”) and an external jump instruction (“EXJMP”).

5. The method of claim 1, wherein the CTT is an internal CTT or an external CTT.

6. The method of claim 5, wherein the internal CTT is an ENDBRANCH and the external CTT is an EXENDBRANCH.

7. A control transfer security method comprising:
determining, by control transfer (CT) logic, whether a target of a control transfer instruction (CTI) is external relative to the CTI; and
implementing, by the CT logic, an internal CTI object code, if the target is not external, or
implementing, by the CT logic, an external CTI object code, if the target is external.

8. The method of claim 7, further comprising determining, by the CT logic, whether the target is accessible only by external other code and tagging, by the CT logic, a target function with an internal control transfer termination (CTT), if the target is not accessible by only external other code, or tagging, by the CT logic, a target object with an external CTT, if the target is accessible only by the external other code.

9. The method of claim 7, wherein the CTI is an internal CTI or an external CTI.

10. The method of claim 9, wherein the internal CTI is selected from the group comprising an internal call instruction (“CALL”) and an internal jump instruction (“JMP”), and the external CTI is selected from the group comprising an external call instruction (“EXCALL”) and an external jump instruction (“EXJMP”).

11. The method of claim 8, wherein the internal CTT is an ENDBRANCH and the external CTT is an EXENDBRANCH.

12. A control transfer security system comprising:
a processor comprising at least one processing unit;
a memory; and
control transfer (CT) logic to determine whether a next instruction is a control transfer termination (CTT) when a prior instruction is a control transfer instruction (CTI); to determine whether the CTT is an external CTT, if the next instruction is the CTT; to determine whether the prior instruction is an external CTI, if the CTT is the external CTT; and to notify an external CTT fault, if the prior instruction is not the external CTI.

13. The system of claim 12, wherein the CT logic is to notify a general CTT fault, if the next instruction is not the CTT.

14. The system of claim 12, wherein the CTI is an internal CTI or an external CTI.

15. The system of claim 14, wherein the internal CTI is selected from the group comprising an internal call instruction (“CALL”) and an internal jump instruction (“JMP”), and the external CTI is selected from the group comprising an external call instruction (“EXCALL”) and an external jump instruction (“EXJMP”).

16. The system of claim 12, wherein the CTT is an internal CTT or an external CTT.

17. The system of claim 16, wherein the internal CTT is an ENDBRANCH and the external CTT is an EXENDBRANCH.

18. A control transfer security system comprising:
a processor comprising at least one processing unit;
a memory; and
control transfer (CT) logic to determine whether a target of a control transfer instruction (CTI) is external relative to the CTI; and to implement an internal CTI object code, if the target is not external, or to implement an external CTI object code, if the target is external.

19. The system of claim 18, wherein the CT logic is to determine whether the target will be accessed only by an external other code, and to tag a target function with an internal control transfer termination (CTT), if the target will not be accessed only by the external other code, or tag a target object with an external CTT, if the target will be accessed only by the external other code.

20. The system of claim 18, wherein the CTI is an internal CTI or an external CTI.

21. The system of claim 20, wherein the internal CTI is selected from the group comprising an internal call instruction (“CALL”) and an internal jump instruction (“JMP”), and the external CTI is selected from the group comprising an external call instruction (“EXCALL”) and an external jump instruction (“EXJMP”).

22. The system of claim 19, wherein the internal CTT is an ENDBRANCH and the external CTT is an EXENDBRANCH.

23. A computer readable storage device having stored thereon instructions that when executed by one or more processors result in the following operations comprising:
determining, by control transfer (CT) logic, whether a next instruction is a control transfer termination (CTT), when a prior instruction is a control transfer instruction (CTI);
determining, by the CT logic, whether the CTT is an external CTT, if the next instruction is the CTT;
determining, by the CT logic, whether the prior instruction is an external CTI, if the CTT is the external CTT; and
notifying, by the CT logic, an external CTT fault, if the prior instruction is not the external CTI.

24. The device of claim 23, further comprising notifying, by the CT logic, a general CTT fault, if the next instruction is not the CTT.

25. The device of claim 23, wherein each CTT is to execute as a NOP (no operation) instruction.
